(19) United States
(12) Patent Application Publication
(10) Pub. No.: US 2011/0270714 A1
(43) Pub. Date: Nov. 3, 2011

(54) ALTERNATE DELIVERY LOCATION METHODS AND SYSTEMS

(75) Inventors: Bob Myrick, Alpharetta, GA (US); David Michel, Alpharetta, GA (US); Jennifer Duff, Roswell, GA (US); Pam Tyler, Woodstock, GA (US); Jerome Bailey, Atlanta, GA (US); Liyan Wang, Atlanta, GA (US); Ken Rankin, Alpharetta, GA (US); Kevin Button, Atlanta, GA (US)

(73) Assignee: UNITED PARCEL SERVICE OF AMERICA,INC

(21) Appl. No.: 13/181,185

(22) Filed: Jul. 12, 2011

Related U.S. Application Data
(63) Continuation of application No. 10/696,180, filed on Oct. 28, 2003.
(60) Provisional application No. 60/423,045, filed on Nov. 1, 2002.

(51) Int. Cl. G06Q 30/00

(52) U.S. Cl. 705/27.1; 705/333

(57) ABSTRACT

Methods and systems disclosed herein are used to deliver a package or product to an alternate delivery location (ADL) for pick up by a customer or authorized retriever. The customer can register to receive delivery of a package or product with an ADL solution provider before delivery of the product, or may do so when purchasing the product. Alternatively, a product or package can be shipped from sender to an ADL for pick up by a person, outside of the context of purchasing a product. The methods and systems also offer the capability to track transported packages or products.

### CROSS-REFERENCE TO RELATED APPLICATIONS

This patent application is a continuation of U.S. patent application Ser. No. 10/696,180, filed Oct. 28, 2003, which claims priority to U.S. Provisional Patent Application No. 60/423,045, filed Nov. 1, 2002, both of which are incorporated herein by reference in there entirety.

### FIELD OF THE INVENTION

The following invention describes a new system and method of shipping and delivering packages via carrier. The invention adds to a conventional shipping arrangement the convenience of having an item shipped to a staffed delivery location instead of the home or business address of the customer for later retrieval by authorized parties.

### BACKGROUND OF THE INVENTION

Prior art shipping and delivery methods customarily entail the shipping of a package to the recipient's home or business address. The optimal delivery situation using these methods exists when a person is present at the delivery location at the time of the first delivery attempt. For a variety of reasons the recipient or other persons may not be at the delivery location at the time of the first delivery attempt. In such circumstances the package must either be left at the location unattended or retained by the carrier for a subsequent delivery attempt or return to the shipper. A package left unattended at the delivery location is susceptible to theft and to damage due to adverse environmental conditions. A package retained by the carrier must be transported back to the delivery location at a later time or returned to the shipper, both or which entail additional costs for the carrier. In addition, failed delivery attempts delay the receipt of the package and may lead to customer dissatisfaction with the services of either the carrier, or the shipper, or both.

In situations where a delivery attempt has failed due to an unoccupied delivery location, some prior art methods involve leaving a communication at the delivery address to inform the recipient that a delivery attempt has been made and that the package will be held at a certain location for pick up by the recipient. This method has the disadvantage of requiring the recipient to travel to a location not of the recipient's choosing. This location may be remote and inconvenient or may not be open for business at times during which the recipient is able to appear there.

Other prior art methods similarly leave a communication at the delivery address except that this communication gives the recipient the option of picking up the package at a set location or authorizing the carrier to leave the package through the use of recipient's signature. This method again has the disadvantage of a set location for recipient pick up, but also requires the carrier to reattempt delivery so that the recipient's decision may be determined (if one, in fact, has been made). If the recipient signed and chose to have the package left outside, the package is exposed to the elements and potential thieves. If the recipient did not sign or made no communication at all, the package must once again be retained by the carrier.

A solution is therefore needed to reduce unsuccessful delivery attempts while protecting package integrity, and at the same time giving recipients flexibility in choosing pick up locations for their packages.

### BRIEF SUMMARY OF THE INVENTION

Methods and systems according to the present invention provide authorized Alternate Delivery Locations (ADL) for designation as the delivery location for packages shipped via carrier. Generally described, the invention allows package recipients to designate an ADL from a list of approved ADLs, which are staffed locations where the package may be retrieved by the recipient or her designated representative.

In a First Embodiment, the method and system are used to facilitate delivery of an item purchased in an electronic commerce or mail order catalog transaction. Prior to the product being shipped, a Buyer communicates with the ADL solution provider (ADL SP) to register for ADL delivery services. This communication is preferably performed via the Internet on the solution provider's website. The customer selects the most convenient ADL address from a list of approved ADLs. This list can be presented by an ADL locator tool on the ADL SP website that allows a Buyer to choose among ADLs that meet criteria provided by the Buyer. A Buyer's ADL selection can be recorded in an Alternate Delivery Location Tracking System (ATS) consisting of at least one processor and at least one database. Other information is solicited and recorded in the ATS at this time including authorized retrievers, preferred notification method(s) (phone, email, pager, etc.), and information necessary to complete notification.

During the communication with the ADL SP, the customer is given an ADL authorization number. The ATS includes an Internet gateway such that the authorization number may be used to view the status of packages shipped to the customer using the ADL method. The number is also used to help verify the identity of the retriever upon arrival at the ADL.

Upon placing an order, the customer uses the address of the ADL as the ship-to address for the purchased product. The product is shipped via carrier to the ADL. Once the package arrives at the ADL the customer is notified of the package's arrival using the notification preferences contained in the ATS. The customer or authorized retriever then travels to the ADL to pick up the package. Once the retriever has been properly identified, the ADL staff transfer the package to the retriever.

In the First Embodiment, the step of providing the ADL address as the ship-to location on the electronic commerce website is automated through the use of a web browser enhancement tool downloaded from the ADL solution provider's web site. This tool records the customer's ADL preferences. Upon the shipping information fields being displayed on the customer's browser, the tool automatically populates the form fields with the recorded information unless the customer overrides.

For the aforementioned embodiment and all subsequent embodiments, the ATS also includes functions accessible by the ADL staff. These functions include viewing all packages sent to, held by, and bound for a given ADL for inventory management purposes. Package receipt time is recorded and a log is retained to track how long a package has been held at the ADL. Package pick up information, including time picked up and identity of the retriever may also be recorded. The ATS also facilitates notification of the customer. The customer is preferably notified automatically, but notification can be accomplished using the notification information in the ATS by the ADL staff

In a Second Embodiment, the selection of an ADL as a delivery location is offered to the customer as a choice by an electronic commerce retailer (or any other business which sells goods in a manner requiring shipment a Buyer) during the ordering process. This can occur by way of an operator offering the option verbally to a customer during a telephone call, or through the option being offered on the shipper's website ordering interface. To accomplish this, shipper must integrate their ordering system/interface with information provided by the ADL solution provider regarding, for example, ADL locations, times of operation, etc. Upon completion of an ADL order, the shipper would then enter or upload the package information into the ATS including ADL address, and customer contact information. This step is preferably automated, but can be performed manually.

In a Third Embodiment, the selection of an ADL would not occur until after at least one failed delivery attempt. In this embodiment, after a failed delivery a communication is left for the recipient at the delivery location. This communication includes a telephone number or web site address. Upon calling the telephone number, or pointing their browser to the web site address, the recipient can direct the carrier to deliver the package to an ADL instead of attempting another delivery at the same location or sending the package back to the shipper.

In a Fourth Embodiment, the ADL method is used in a “person to person” shipping context not directly associated with a purchase. In this embodiment, a sender either enrolls in the ADL service as in the First Embodiment or is offered the ADL service at the time of shipment in a manner similar to the Second Embodiment. This Fourth Embodiment does not involve a seller of goods, merely a sender and a recipient. The package is shipped to an ADL near to the intended recipient. The ATS contains the contact information for the intended recipient and any authorized retrievers. The ATS or the ADL staff contact the recipient or retriever(s) upon the package's arrival at the ADL and hold the package for retrieval.

### BRIEF DESCRIPTION OF THE SEVERAL VIEWS OF THE DRAWING(S)

FIG. 1 is a block diagram of a system for delivering a package to an alternate delivery location (ADL) in which a Buyer can enroll or register with an ADL service to have a package shipped to an ADL of choice, according to a First Embodiment of the invention.

FIG. 2 is a flowchart of a general method for delivering a package to an ADL for pickup by a Buyer or Retriever, according to the First Embodiment of the invention.

FIG. 3 is a relatively detailed flowchart of a “consumer pull” embodiment of a method for delivering a package to an ADL for pickup by a Buyer or Retriever, according to the First Embodiment of the invention.

FIG. 4 is a block diagram of a system in which a Buyer purchases a product from a Seller and selects an ADL to which to deliver the product for pickup, according to a Second Embodiment of the invention.

FIG. 5 is a flowchart of a method involving a Buyer purchasing a product and indicating an ADL for delivery of the product for pickup by the Buyer or an authorized Retriever, according to the Second Embodiment of the invention.

FIG. 6 is a relatively detailed flowchart of a “shipper push” embodiment of a method for delivering a product to an ADL for pickup by a Buyer or authorized Retriever, according to the Second Embodiment of the invention.

FIG. 7 is a flowchart of a method in which a first delivery attempt is made to deliver a product to a Buyer's designated address, and in the event that the Buyer is enable to accept the package, the Carrier delivers the product to an ADL for pickup by Buyer or an authorized Retriever.

FIG. 8 is a block diagram of a system in which a Sender of a product determines the ADL to which the product is to be shipped for pickup by the Buyer or authorized Retriever.

FIG. 9 is a block diagram of contractual relationships between various parties in an ADL system.

### DETAILED DESCRIPTION OF THE INVENTION

The present invention is described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

An Alternative Delivery Location Service Provider (ADL SP) coordinates the Alternative Delivery Location (ADL) method. An ADL SP provides the parties to an ADL transaction the functions and facilities to complete a transaction according to the ADL method. The functions and facilities provided include, but are not limited to: obtaining written agreements from staffed ADL locations that consent to package delivery at their address according to the ADL method and the creation, maintenance, and support of an Alternate Delivery Location Service Processing and Tracking System (ATS).

The ATS comprises at least one processor, at least one database and a number of tools designed to interact with that database. The ATS also preferably comprises at least one web server. The ATS tools serve to enable the appropriate party to add to, change, or view the data contained in the ATS database. Examples of these tools include Internet gateways to the ATS that allow: customer tools that enable registration as an ADL customer, downloading of the web browser enhancement, and viewing of package data; Seller tools (used in the Second Embodiment) that enable the entering of customer data and preferences, the entering of packages into the ATS, the viewing of customer data, the viewing of package data, and the viewing of Seller specific reports; ADL tools that enable the viewing of ADL reports and the entering of package data such as time and date package received at ADL, time and date of package pickup and retriever name; inventory management tools; and communication tools that include notification tools for contacting Buyers or their authorized retrievers.

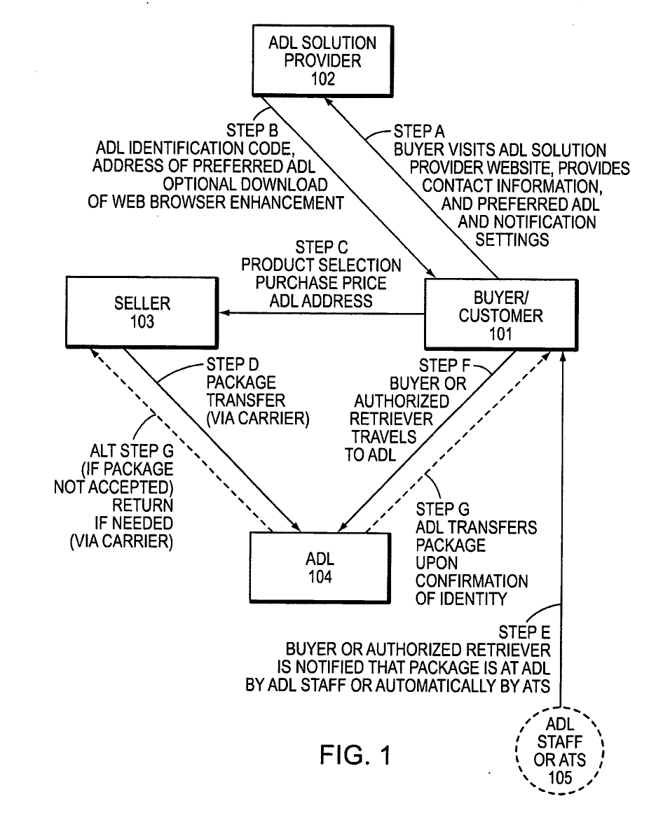

FIG. 1 depicts the interactions between parties involved in a transaction according to the First Embodiment of the invention. In this Embodiment a Buyer 101, who is a person desiring to buy goods, registers or enrolls for an ADL service by contacting an ADL SP 102. This action is depicted in Step A on FIG. 1. This communication preferably occurs via the Internet where a Buyer 101 points a web browser to the website of the ADL SP 102. The Buyer 101 transfers the appropriate contact information for himself and any others authorized to retrieve packages sent to him using the ADL service and desired methods of notification. Notification methods include, but are not limited to: telephone, voicemail, email, text messaging, pager. The preferred Alternate Delivery Location can be chosen from a list of authorized locations that have agreements with the ADL SP to hold packages for customer retrieval. A conventional locator program can be provided to enable a Buyer to find the ADL closest to the Buyer's location. The ADL SP 102 stores this information in a database on an appropriate server.

As depicted in Step B of FIG. 1, the ADL SP 102 issues an ADL Identification Number to the Buyer 101 and detailed address information regarding the ADL location chosen by the Buyer. This information is recorded by the Buyer. The ADL Identification Number can be used in conjunction with the ATS to view the status of packages sent using the ADL service by Buyer. Optionally, a web browser enhancement may be downloaded from the ADL SP to the Buyer's browser for the purpose of recording the address information of the chosen ADL and retaining it for later automatic placement in ship-to form fields of electronic commerce websites.

As depicted in Step C of FIG. 1, when the Buyer 101 later makes a purchase requiring shipment of the product purchased from Seller 103, the Buyer gives the address of his preferred ADL location as the ship-to address for the purchase. If this transaction occurs via the Internet and the web browser enhancement was downloaded by Buyer from the ADL SP website, the ship-to form fields can be automatically filled with the appropriate information. The Seller then ships the package to the ADL 104 via carrier as depicted in Step D. The carrier picks up the package and the package data is uploaded to the carrier tracking system (CTS). The CTS can be in communication with the ATS such that information from the two systems is shared.

As depicted in Step E of FIG. 1, once the package arrives at the ADL an upload is made to the ATS 105 denoting the package as “delivered”, the Buyer or his designated authorized retriever is notified that the package is ready to be picked up. This notification can be made by the staff of the ADL 104 using the contact information in the ATS corresponding to the package, or preferably, the ATS 105 provides notification automatically according to the Buyer preferences. The Buyer or authorized retriever then can travel at his convenience to the ADL as depicted in Step F.

The package is held for the Buyer 101 at the ADL 104 for a time designated in the agreement between the ADL and the ADL SP. If, the Buyer or his authorized retriever appears at the ADL with appropriate identification, the ADL staff will offer the package for inspection by the retriever. Upon acceptance by the retriever, the ADL staff will transfer the package to the retriever, as depicted in Step G of FIG. 1. If the package is rejected, or an authorized retriever fails to appear at the ADL during the package holding period, the package is returned to the Seller 103 via carrier as depicted in Step G of FIG. 1.

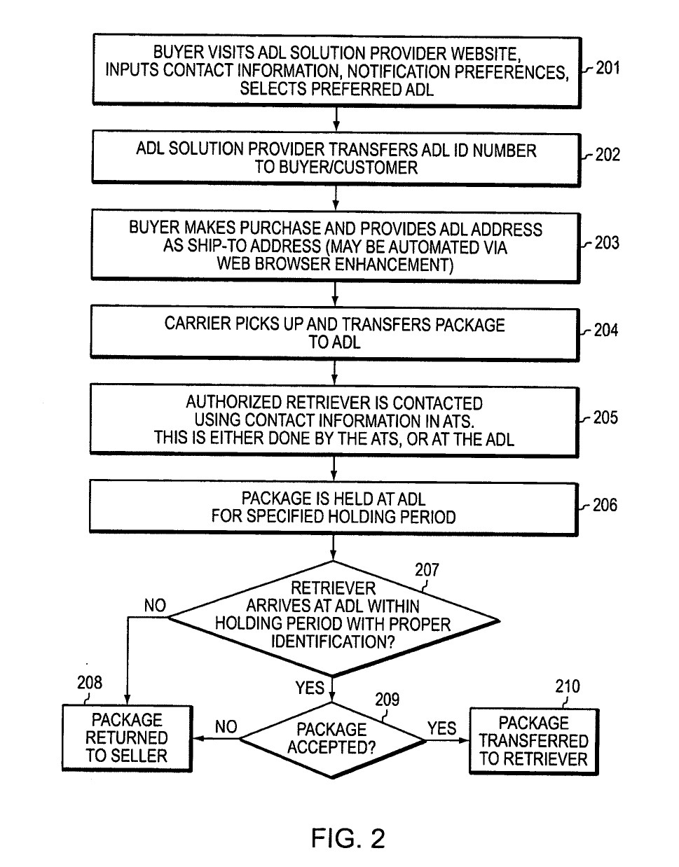

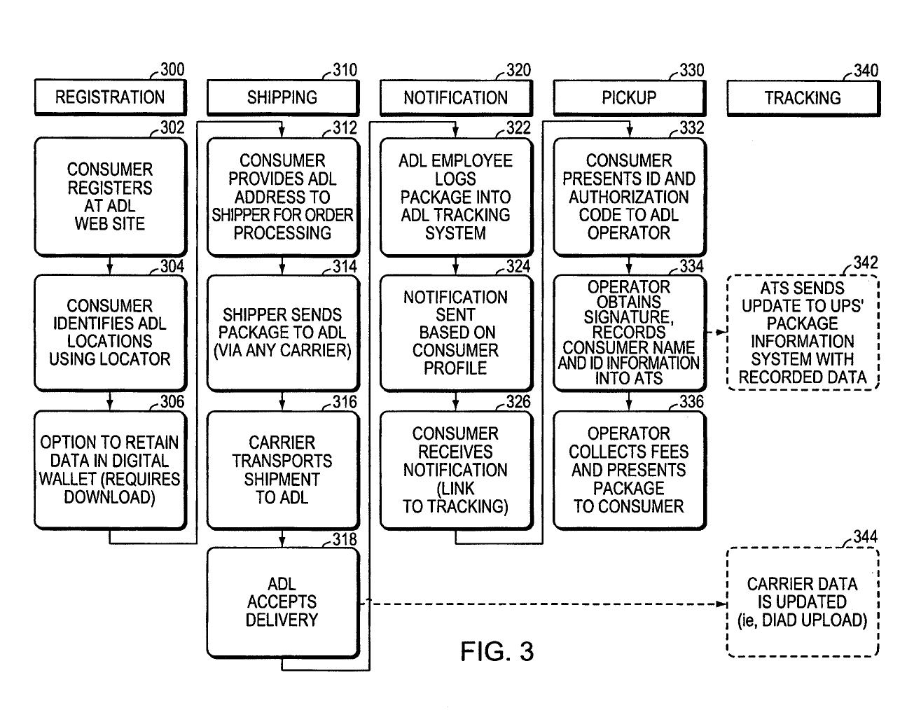

The flowcharts of FIGS. 2 and 3 further illustrate the steps of a transaction according to the First Embodiment of the invention.

Referring to FIG. 2, a Buyer first visits the ADL SP Website at step 201. Here the Buyer enrolls in the ADL service. Data such as contact information (including name, address, phone number, and email address), notification preferences (including notification method—phone, email, or pager number), and authorized retrievers among other data is solicited from the Buyer. Buyer is also shown a list of ADLs that accept packages under the ADL SP's program. The list can be provided through a locator tool that only displays those ADLs within a convenient distance from Buyer. Buyer selects one or more ADLs for delivery of packages. Data provided by Buyer is recorded for transfer (either immediate or delayed) into the ATS. During or after enrollment Buyer is offered the opportunity to download an optional web browser enhancement that will facilitate use of the ADL solution. The enhancement will record Buyer's chosen ADL and fill in the appropriate ship-to form fields upon Buyer making an online purchase. After enrollment is complete, at step 202 the ADL SP website creates a unique identification number for Buyer, transfers this number and the address of the chosen ADL to Buyer, and Buyer is instructed to record this number for future use (if the web browser enhancement tool was downloaded, the tool will record the ADL address information for the Buyer).

Sometime after enrollment in the ADL program, Buyer makes a purchase at step 203. This purchase is preferably made online via the Internet, but it can also be made via phone-in order, mail order catalog, or in a retail store. Any transaction that requires that a product be shipped to a recipient is within the scope of the invention. Buyer gives the Seller the address of the chosen ADL. If the transaction is being made via the Internet, and the web browser enhancement was downloaded, the ship-to fields will be filled automatically. Seller engages a carrier which at step 204 then picks up the package and ships it to the ADL address provided.

Upon transfer of the package, the ATS is updated to reflect the delivery of the package to the ADL, and a notification communication is sent to Buyer at step 205. The ATS update and the sending of this message can be completed automatically if the carrier's tracking system is integrated with the ATS. Alternatively, the notification can be made automatically by the ATS upon the ADL staff updating the package status, by the staff executing a notification command within the ATS interface or simply by the ADL staff placing a phone call, or sending an email or page manually. The Buyer is notified according to the preferences chosen by Buyer in step 201. If the notification message is sent via email, the message can include a link to the ATS system that provides package details to the recipient.

After notification of Buyer or his authorized retriever(s) that the package has arrived, the ADL holds the package for a specified holding period at step 206 (period is set by the agreement between the ADL and the ADL SP). The next action by the ADL depends on whether either Buyer or an authorized retriever appears during the holding period 207. If no one appears at the ADL to pick up the package, the package is returned to the Seller. At step 208, if Buyer or an authorized retriever arrives at the ADL during the holding period, the ADL will verify their identity. Identity can be verified through the use of the ADL identification number issued in 202, or other forms of Identification. ADL staff also may obtain a signature from the retriever. Buyer or his authorized retriever may be given an opportunity at step 209 to reject the shipment at this point depending on the return policies of the Seller. At step 208, if the Buyer rejects the package it is sent back to the Seller via a carrier. If the package is accepted, Buyer departs the ADL with the package at step 210. In either instance, the ATS is updated to reflect the event.

FIG. 3 outlines a substantially similar process as FIG. 2, with alternative organization. The process of FIG. 3 generally comprises five steps: registration 300, shipping 310, notification 320, pickup 330, and tracking 340.

In registration step 300, the consumer registers at an ADL web site to use the ADL service (substep 302). The consumer also identifies the ADL of choice using a locator available at the ADL web site (substep 304). The consumer can further obtain a digital wallet downloaded from the ADL web site, for which the consumer has been pre-charged. The consumer is charged for use of the ADL service by deducting the cost of shipment from the credits contained in the digital wallet (substep 306).

In the Shipping step 310 of FIG. 3, the consumer provides an ADL address to the shipper for order processing in the purchase of a product (substep 312). The shipper then sends the package containing the purchased product to the ADL (substep 314). The shipper notifies the carrier that the package is ready to be shipped to the ADL. The carrier obtains the package from the shipper and transports the shipment or package to the ADL (substep 316). The ADL accepts delivery of the shipment or package (substep 318) to complete the Shipping step 310.

The notification step 320 of FIG. 3 can comprise the following substeps. The ADL employee logs the package into the ATS 105 (substep 322). The ADL employee can thus access the ATS 105 using a computer at the ADL. The ADL employee accesses the ATS 105 to retrieve the consumer profile containing the consumer's preference for contact, and notifies the consumer that the package is available for pick up (substep 324). The consumer then receives notification from the ADL employee that the package is available for pick up (substep 326), and arranges to pick up the package from the ADL 105.

The pickup step 330 of FIG. 3 can comprise the following substeps. The consumer presents identification and optionally also an authorization code to the ADL operator (substep 332). The operator obtains the consumer's signature and records the consumer's name and identification information into the ATS 105 (substep 334) to establish a record of the fact that the package was picked up, and the identity of the person picking up the package. The ADL operator collects fees from the consumer and presents the package to the consumer (substep 336). The collection of fees can be done by deducting fees from the consumer's digital wallet, or the consumer may elect to pay by cash, credit card or other means.

The tracking step 340 of FIG. 3 can comprise the following substeps. The ATS can send the package data and recorded data obtained in substep 334 to a computer system of the carrier, which permits tracking of the package. Moreover, upon acceptance of delivery of the package at the ADL, an employee of the carrier can use Delivery Information Acquisition Device (DIAD), a handheld unit used by carrier personnel, to transmit data such as the date and time of delivery, the identity and signature of the ADL employee accepting the delivery, data identifying the relevant ADL, and possibly other data. This data is received by the carrier computer system for the carrier's use in tracking and maintaining a record of the shipment and delivery of the package to the ADL 104.

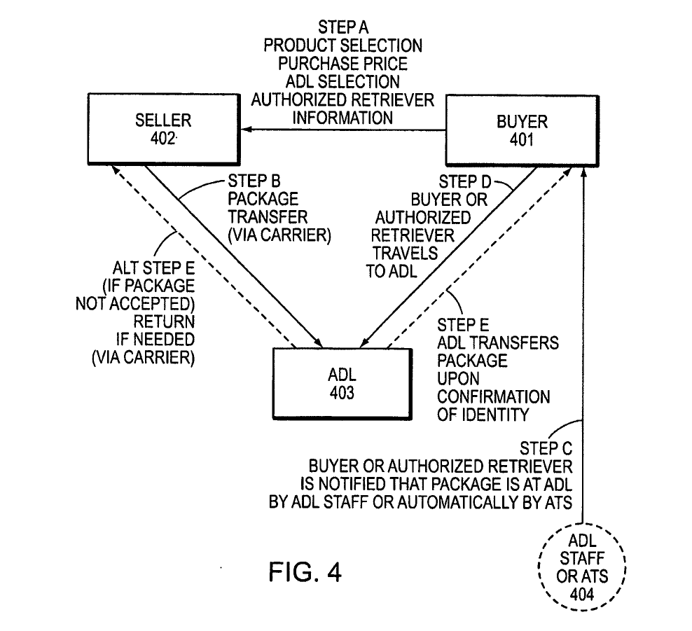

FIG. 4 depicts the interactions between parties involved in a transaction according to the Second Embodiment of the invention. As illustrated by Step A of FIG. 4, Buyer 401 communicates with Seller 402 regarding a decision to purchase a product from Seller. This communication can occur in a number of ways, including, but not limited to the Buyer: visiting the Seller's website, calling Seller's sales department, traveling to Seller's place of business, or placing an order via catalog. The communication preferably occurs via the Internet at Seller's website. At the time the purchase decision is made, the Seller offers the Buyer the choice of having the package shipped to an ADL. This choice can be offered via Internet, telephone, mail-order catalog form, or in person. Therefore, an agreement must exist between the Seller 402 and the ADL(s) or an ADL SP prior to an ADL delivery being offered to the Buyer. If the Buyer chooses an ADL delivery, the Seller 402 provides Buyer 401 with a list of convenient ADLs in Buyer's vicinity. A conventional locator program can be provided to enable a Buyer to find the ADL closest to the Buyer's location. The Buyer chooses one of these locations as the ship to address for the package.

The package is shipped to the chosen ADL via carrier, Step B of FIG. 4. As depicted in Step C of FIG. 4, once the package arrives at the ADL, the Buyer or his designated authorized retriever is notified that the package is ready to be picked up. This notification can be made by the staff of the ADL 404 using the contact information in the ATS corresponding to the package, or preferably, the ATS 404 provides notification automatically according to the Buyer's preferences. The Buyer or his authorized retriever then can travel at his convenience to the ADL as depicted in Step D.

The package is held for the Buyer 401 at the ADL 403 for a time designated in the agreement between the ADL and the Seller or ADL SP. If, the Buyer or his authorized retriever appears at the ADL with appropriate identification, the ADL staff will offer the package for inspection by said retriever. Upon acceptance by the retriever, the ADL staff will transfer the package to the retriever, as depicted in Step E of FIG. 4. If the package is rejected, or an authorized retriever fails to appear at the ADL during the package holding period, the package is returned to the Seller 402 via carrier as depicted in Step E of FIG. 4.

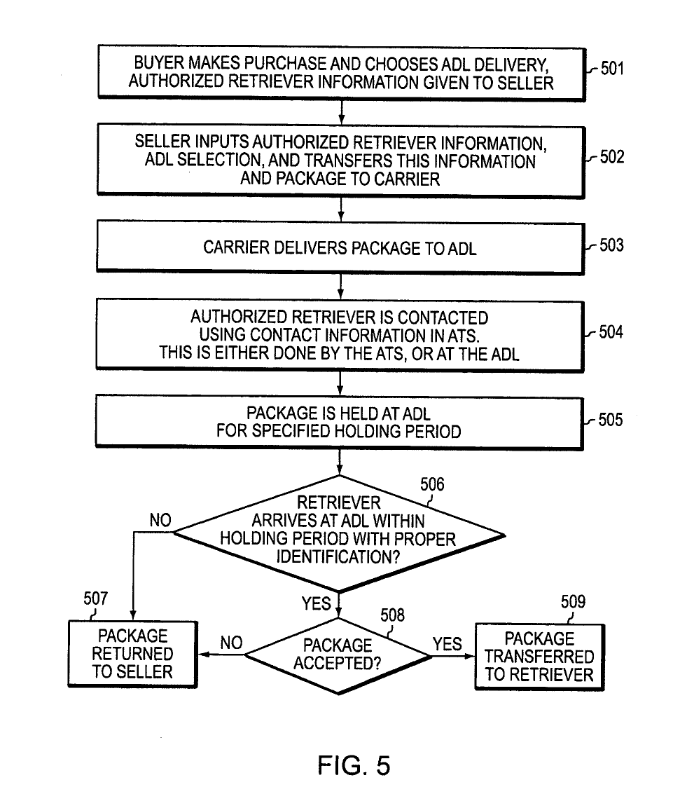

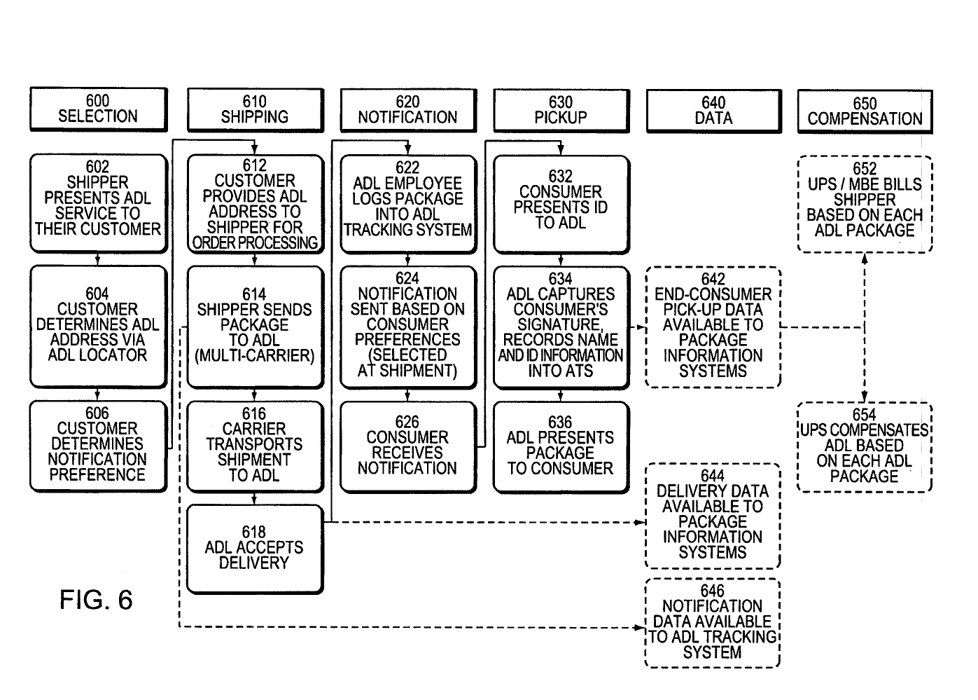

The flowcharts of FIGS. 5 and 6 further illustrate the steps required to complete a transaction according to the Second Embodiment of the invention.

Referring to FIG. 5, Buyer decides to make a purchase from Seller and utilize the ADL shipping option offered by Seller at step 501. Data such as contact information (including name, address, phone number, and email address), notification preferences (including notification method—phone, email, or pager number), and authorized retrievers among other data is solicited from the Buyer. Buyer is also offered a list of ADLs that accept packages from the ADL program in which Seller is a participant. The list can be provided through a locator tool that only provides those ADLs within a convenient distance from Buyer. Buyer selects an appropriate ADL for delivery of packages. Data provided by Buyer is recorded for transfer (either immediate or delayed) into the ATS at step 502. Carrier then picks up the package and ships it to the ADL address provided at step 503.

Upon transfer of the package, the ATS is updated to reflect the delivery of the package to the ADL, and a notification communication is sent to Buyer at step 504. The ATS update and the sending of this message can be completed automatically if the carrier's tracking system is integrated with the ATS. Alternatively, the notification can be made automatically by the ATS upon the ADL staff updating the package status, by the staff executing a notification command within the ATS interface or simply by the ADL staff placing a phone call, or sending an email or page manually. The notification is made according to the preferences chosen by Buyer in step 502. If the notification message is sent via email, the message can include a link to the ATS system that provides package details to the recipient.

After notification of Buyer or his authorized retriever(s) that the package has arrived, the ADL holds the package for a specified holding period at step 506 (period is set by the agreement between the ADL and the ADL SP). The next action by the ADL depends on whether either Buyer or an authorized retriever appears during the holding period at step 507. If no one appears at the ADL to pick up the package, the package is returned to the Seller. If Buyer or an authorized retriever arrives at the ADL during the holding period the ADL will verify their identity. ADL staff also may obtain a signature from the retriever. Buyer or his authorized retriever may be given an opportunity to reject the shipment at this point depending on the return policies of the Seller. If the Buyer rejects the package it is send back to the Seller via carrier. If the package is accepted, Buyer departs the ADL with the package. In either instance, the ATS is updated to reflect the event.

FIG. 6 outlines substantially the same process as FIG. 5, with alternative organization. In FIG. 6 the process comprises the following steps: Selection 600, Shipping 610, Notification 620, Pickup 630, Data Acquisition 640, and Compensation 650. The Selection 600 comprises the following substeps. The shipper presents the ADL service to its customer (substep 602). This can be done via the ADL website, mail order catalog, retail store, telephone, or through other means. The consumer determines the ADL address of the consumer's choice using the ADL locator (substep 604). In many cases, this is the ADL most convenient or closest to the consumer. Furthermore, the consumer determines the notification preference for receiving notification of the fact that the package has arrived at the ADL (substep 606). Notification can be offered through a number of different media, including Internet access of a page notifying the consumer, email, pager, a telephone call to the consumer, a card sent to the user, a personal notification, etc.

In the Shipping step 610 the consumer provides the selected ADL address to the shipper to process the shipment order (substep 612). The shipper sends the package to the ADL (substep 614). More specifically, the carrier is notified that the shipment is ready for transport to the consumer, and the carrier picks the package up from the shipper. The carrier transports the shipment from the shipper to the ADL (substep 616). The ADL then accepts delivery of the package (substep 618).

In the Notification Step 620, the ADL employee accesses and logs the package into the ATS 105 (substep 622) using a networked computer. The ADL employee can access the ATS 105 and retrieve customer preferences stored in a database thereof (substep 624). The ADL employee notifies the consumer that the package is available for pickup using the notification media selected by the consumer, as indicated by the retrieved data. The consumer receives the notification and is thereby notified that the package is available for pick up at the ADL (substep 626).

In the Pickup Step 630, the consumer presents identification such as a driver's license or other form of identification, to the ADL employee for verification of the consumer's identity (substep 632). This ensures that the package is delivered to the proper consumer. The ADL employee captures the consumer's signature, and records the consumer's name and identification information using the ATS 105 (substep 634). This ensures that the consumer has acknowledged receipt of the package in case a later question arises as to whether the package was in fact delivered to the consumer. To complete Pickup Step 630, the ADL employee presents the package to the consumer (substep 636).

In the Data Acquisition Step 640, the ATS 105 transmits consumer pick-up data to the carrier's computer system so that the carrier can track the package (substep 642). In addition, the carrier's computer system receives delivery data related to the ADL's acceptance of the package from the carrier (substep 644). Moreover, the carrier computer system receives notification data from the shipper that the package is ready to be picked up for shipment to the ADL (substep 646). By collecting this data, the ATS 105 can maintain a record of the status of the package in shipment from the shipper to the ADL, to delivery to the consumer at the ADL.

In the Compensation Step 650, the carrier and ADL bill the shipper for charges incurred for processing the ADL package (substep 652). The carrier receives payment from the shipper and compensates the ADL 105 for storing and processing the ADL package. Alternatively, the consumer may pay the ADL 105 for shipment of the package when picking up the package at the ADL, and the ADL then forwards payment to the carrier to compensate the carrier for shipment charges.

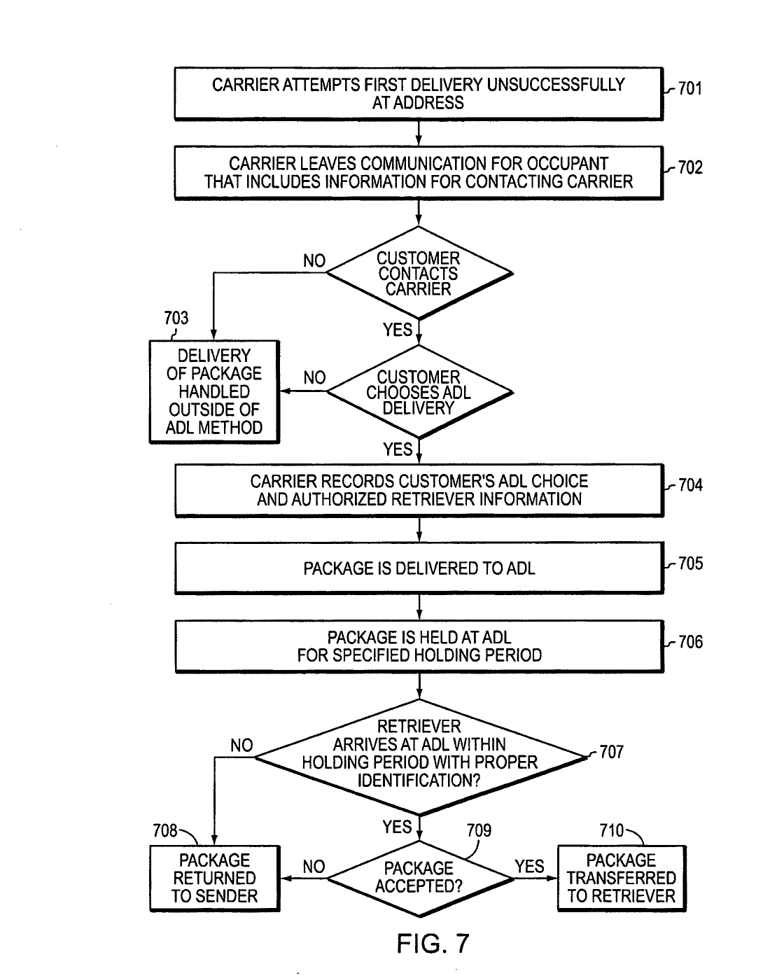

FIG. 7 is a flowchart that depicts the ADL method according to the Third Embodiment of the invention. According to the Third Embodiment, a carrier first attempts a routine delivery, but is unsuccessful (step 701). The carrier then leaves a communication at the delivery address informing the occupant of the attempted delivery at step 702. The communication also offers the occupant the option of having the package sent to an ADL. The communication includes a phone number that the customer may call, or a website address that the customer may visit to instruct the carrier to deliver the package to an ADL instead of attempting to redeliver the package. If the customer does not contact the carrier, the carrier will follow the procedure normally used in cases of failed deliveries (step 703). If the customer does contact the carrier and chooses to have the package delivered to an ADL the carrier will record the customer's choice of ADL (if choices are available) as well as authorized retriever information at step 704. Carrier then delivers package to the ADL at step 705. The ADL holds the package for a specified holding period at step 706 (period is set by the agreement between the ADL and the carrier). The next action by the ADL depends on whether either Buyer or an authorized retriever appears during the holding period at step 707. If no one appears at the ADL to pick up the package in step 707, the package is returned to the Seller in step 708. If Buyer or an authorized retriever arrives at the ADL during the holding period the ADL will verify their identity. ADL staff also may obtain a signature from the retriever. If the Buyer rejects the package in step 709 it is send back to the Seller via carrier in step 708. If the package is accepted in step 709, Buyer leaves the ADL with the package in step 710.

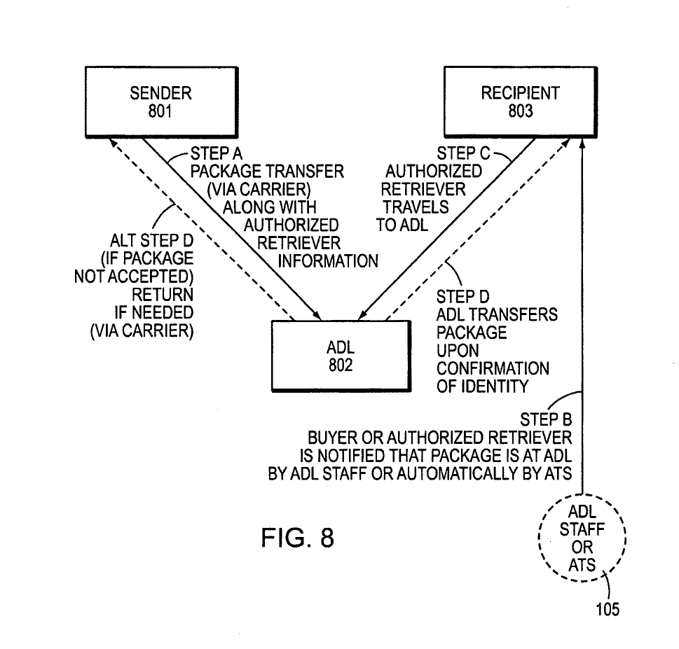

FIG. 8 depicts the interactions between parties involved in a transaction according to the Fourth Embodiment of the invention. As illustrated by Step A of FIG. 8, Sender 801 ships package to ADL 802 via carrier. It should be appreciated that the process illustrated in FIG. 8 can be accomplished by the Sender signing up for the ADL service before shipping the package in a manner similar to the First Embodiment, or by the ADL service being offered at the point of shipment in a manner similar to the Second Embodiment. In the Fourth embodiment, however, the Sender of the package selects the ADL location instead of the recipient of the package. Also, the Sender must select authorized retrievers on a per package basis at the time of shipment.

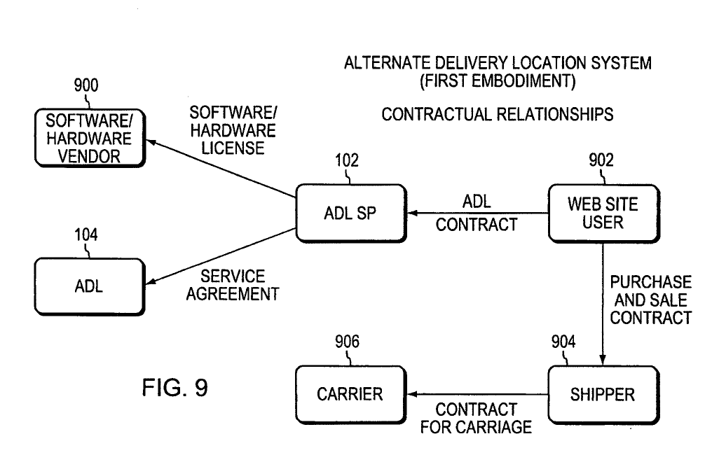

FIG. 9 illustrates the contractual arrangements typically utilized in connection with the First Embodiment of the invention. Contractual arrangements for other embodiments should become readily apparent from this description. The ADL SP 102 enters into service agreement with the ADL 104 to permit the ADL SP 102 to offer the ADL 104 as one possible location for shipment of a package. The ADL 104 can be one location in a chain or franchise with which the ADL SP 102 contracts, or it can be a single location, preferably with a large volume of ADL business. The ADL SP 102 also enters into a hardware and/or software license or purchase agreement with Vendor 900 to provide any software and hardware necessary for the ADL SP 102 and ADL 104 to manage and operate the ADLs, including such equipment as the ATS 105, the ADL computer system with servers, gateways, and firewalls, the database storage system, etc. required to provide the ADL service. With these contracts in effect and the equipment and software operable, the ADL SP 102 launches a website offering the ADL service to website users. The website user 902 enters into an ADL contract with ADL SP 102 to provide ADL service. When shopping on the Internet, the website user 902 enters into a purchase and sale contract with shipper 904 to purchase a product. The shipper 904 enters into a contract with carrier 906 to ship the product to the ADL for delivery to the user (also referred to as customer, buyer, or consumer) 902. The contracts related to the First Embodiment of the invention are thus effected.

That which is claimed:

1. A method for managing delivery of an product to an alternately delivery location for subsequent pickup, the method comprising the steps of:
electronically receiving an address of a user prior to the purchase of the product;
electronically providing the user a plurality of alternative delivery locations to which a package may be delivered, wherein the plurality of alternative delivery locations are provided electronically based at least in part on the proximity of the alternative delivery locations to the address of the user;
electronically receiving a selection of a particular alternative delivery location from the plurality of alternate delivery locations;
electronically generating a unique identification number identifying the user;
electronically storing the unique identification number in association with the address of the alternative delivery address and the address of the user;
electronically providing the unique identification number and the address of alternative delivery location to the user;
after the product is received at the alternative delivery notification, electronically notifying the user; and
authorizing release of the product to the user or an agent of the user.

2. The method for managing delivery of claim 1 further comprising the steps of:
providing the user with a web browser enhancement tool that resides in the user's browser;
retrieving the selected alternate delivery location from the web browser enhancement tool for use in shipping the product to the user upon notification that the user has purchased the product from a vendor; and
providing the selected alternate delivery location to the vender's computer system to use as the shipping location for the product purchased by the user via the web browser enhancement tool automatically populating form fields of a vendor web page to provide the selected alternate delivery location address for upload to the vender's computer system.

3. The method for managing delivery of claim 2, wherein the web browser enhancement tool is configured to:
record and retain the selected alternate delivery location; and
provide a digital wallet that is configured to allow the user to purchase credits, the credits being used to pay a fee to a alternate delivery location service provider each time the user elects to use the selected alternate delivery location as a shipping location;

4. The method for managing delivery of claim 1 further comprising the steps of:
receiving identification information of at least one retriever authorized by the user to pick up the product at the selected alternate delivery location and the computer system storing the identification information in memory; and
retrieving the identification information at the selected alternate delivery location indicating that the retriever is authorized to receive the product.

5. The method for managing delivery of claim 1 further comprising the step of:
notifying the user that the product is available for pickup at the selected alternate delivery location.

6. The method for managing delivery of claim 1 further comprising the step of:
electronically storing a preferred media for receiving notification that the product has arrived at the alternate delivery location in the memory, wherein the preferred notification media is selected from the group consisting of a telephone, an email, a pager, and
wherein the step of notifying is performed using the user's preferred media.

7. The method for managing delivery of claim 6, wherein an alternate delivery location tracking computer system (ATS) retrieves the information of the preferred indication media from the memory and notifies the user of arrival of the product at the alternate delivery location via the preferred indication media.

8. The method for managing delivery of claim 1 further comprising the step of:
providing access, based at least in part on the unique identification number, to an alternate delivery location tracking computer system (ATS) to determine a status of the product in shipment from a vendor of the product to the ADL.

9. The method for managing delivery of claim 1, further comprising the steps of:
storing a date of arrival of the product at the alternate delivery location in the memory; and
tracking how long the package has been held by the alternate delivery location.

10. An apparatus comprising at least one processor and at least one memory including computer program code, the at least one memory and the computer program code configured to, with the processor, cause the apparatus to at least:
receive an address of a user prior to the purchase of the product;
provide the user a plurality of alternative delivery locations to which a package may be delivered, wherein the plurality of alternative delivery locations are provided electronically based at least in part on the proximity of the alternative delivery locations to the address of the user;
receive a selection of a particular alternative delivery location from the plurality of alternate delivery locations;
generate a unique identification number;
store unique identification number in association with the address of the alternative delivery address and the address of the user;
provide the unique identification number and the address of alternative delivery location to the user;
after the product is received at the alternative delivery notification, notify the user; and
authorize release of the product to the user or an agent based at least in part on the unique identification number.

11. The apparatus of claim 10, wherein the computer program code is further configured to cause the apparatus to:
provide the user with a web browser enhancement tool that resides in the user's browser;
retrieve the selected alternate delivery location from the web browser enhancement tool for use in shipping the product to the user upon notification that the user has purchased the product from a vendor; and
provide the selected alternate delivery location to the vender's computer system to use as the shipping location for the product purchased by the user via the web browser enhancement tool automatically populating form fields of a vendor web page to provide the selected alternate delivery location address for upload to the vender's computer system.

12. The apparatus of claim 11, wherein the web browser enhancement tool is configured to:
record and retain the selected alternate delivery location; and
provide a digital wallet that is configured to allow the user to purchase credits, the credits being used to pay a fee to a alternate delivery location service provider each time the user elects to use the selected alternate delivery location as a shipping location;

13. The apparatus of claim 10, wherein the computer program code is further configured to cause the apparatus to:
receive identification information of at least one retriever authorized by the user to pick up the product at the selected alternate delivery location and the computer system storing the identification information in memory; and
retrieve the identification information at the selected alternate delivery location indicating that the retriever is authorized to receive the product.

14. The apparatus of claim 10, wherein the computer program code is further configured to cause the apparatus to:
notify the user that the product is available for pickup at the selected alternate delivery location.

15. The apparatus of claim 10, wherein the computer program code is further configured to cause the apparatus to:
store a preferred media for receiving notification that the product has arrived at the alternate delivery location in the memory, wherein the preferred notification media is selected from the group consisting of a telephone, an email, a pager, and
wherein the notifying is performed using the user's preferred media.

16. The apparatus of claim 10, wherein the computer program code is further configured to cause the apparatus to:
provide access, based at least in part on the unique identification number, to an alternate delivery location tracking computer system (ATS) to determine a status of the product in shipment from a vendor of the product to the ADL.

17. The apparatus of claim 10, wherein the computer program code is further configured to cause the apparatus to:
store a date of arrival of the product at the alternate delivery location in the memory; and
track how long the package has been held by the alternate delivery location.
